(19) United States
(12) Patent Application Publication
(10) Pub. No.: US 2011/0061243 A1
(43) Pub. Date: Mar. 17, 2011

(54) ATTACHMENT COMB FOR HAIR TRIMMER

(76) Inventor: Adriaan Smit, Portland, OR (US)

(21) Appl. No.: 12/881,622

(22) Filed: Sep. 14, 2010

Related U.S. Application Data
(60) Provisional application No. 61/242,766, filed on Sep. 15, 2009.

(51) Int. Cl. B26B 13/00

(52) U.S. Cl. 30/233.5

(57) ABSTRACT

A comb comprising a base configured to secure the comb to a trimming device, primary teeth configured to provide a fixed distance from a cutting edge of the trimming device, and secondary teeth configured to manipulate hair to a predetermined orientation relative to the cutting edge.

### CROSS-REFERENCE TO RELATED APPLICATIONS

This application claims priority to U.S. Provisional Patent Application No. 61/242,766 filed Sep. 15, 2009, entitled ATTACHMENT COMB FOR HAIR TRIMMER, the specification of which is hereby incorporated in its entirety.

### BACKGROUND

Personal grooming devices, such as hair trimming devices, more commonly known as hair dippers, use combs that are designed to cut the hair to a relatively fixed length by keeping the trimmer cutting edge at a particular distance from the skin surface. Combs of various sizes provide a range of different spacings between the skin surface and the trimmer cutting edge, where each different comb size corresponds to a desired hair length.

Examples of personal grooming devices are found in U.S. Pat. Nos. 3,648,370; 3,969,819; 4,614,036; 4,622,745; 5,937,526; 6,079,103; 7,051,442; D286,454; and D555,793 the disclosures of which are incorporated herein by reference, in theft entirety and for all purposes.

### SUMMARY

The present disclosure is directed to an attachment comb for a hair trimming device. In one embodiment, the comb includes a base configured to secure the comb to a trimming device, primary teeth configured to provide a fixed distance from a cutting edge of the trimming device, and secondary teeth configured to manipulate hair to a predetermined orientation relative to the cutting edge.

### BRIEF DESCRIPTION OF THE DRAWINGS

FIG. 1 illustrates a top perspective view of an exemplary comb.

FIG. 2 illustrates a bottom perspective view of an exemplary comb.

FIG. 3 illustrates a bottom front perspective view of an exemplary comb.

FIG. 4 illustrates a front perspective view of an exemplary comb.

FIG. 5 illustrates a bottom view of an exemplary comb.

FIG. 6 illustrates a top view of an exemplary comb.

FIG. 7 illustrates a back view of an exemplary comb.

FIG. 8 illustrates a front view of an exemplary comb.

FIG. 9 illustrates a side view of an exemplary comb.

FIG. 10 illustrates a transparent side view of an exemplary comb.

FIG. 11 is a bottom perspective photograph nf an exemplary comb rapid prototyped with acrylonitrile butadiene styrene (ABS) plastic.

FIG. 12 is a top perspective photograph of the exemplary comb of FIG. 11.

FIG. 13 is a bottom perspective photograph of a current trimming device.

FIG. 14 is a top perspective photograph of the trimming device of FIG. 13.

FIG. 15 is a front perspective photograph of the exemplary comb attached to the trimming device.

FIG. 16 is a bottom perspective photograph of the trimmer and comb of FIG. 15.

FIG. 17 is a top perspective photograph of the trimmer and comb of FIG. 15.

### DETAILED DESCRIPTION AND BEST MODE

A common problem with existing hair trimmer combs is their inability to sufficiently reorient the hair away from the skin and uniformly bring the hair towards the trimmer cutting edge. Current combs are designed to ensure that the trimmer cutting edge is a particular distance away from the skin surface. Such designs have relatively wide teeth and spacing between the teeth and do not sufficiently orient or position the hair relative to the cutting edge. Cutting the hair to a uniform length with current combs relies on the assumption that the hair naturally stands up straight or is already oriented perpendicular to the surface of the skin. If this is not the case and the hair is oriented at any other angle, the existing combs do not have the mechanical leverage or ability to align the hair with the trimmer cutting edge. This results in hair that is cut to various lengths depending on the orientation when cut.

This inefficiency forces hair stylists to either run the trimmer through the hair multiple times in various directions in the hope that the hair gets pushed around enough to eventually be cut uniformly, or to use the hair trimmer in combination with a traditional hair comb. The hair comb is used to first re-orient the hair so that the trimmer achieves a more uniform cut. Without this additional effort, some hairs will not be properly oriented to the cutting edge and will not be cut to the intended length.

This inability of current combs to align hair with the trimmer cutting edge is particularly evident when the length of the hair being out is already close to the desired length. In this instance the only way to achieve a uniform out is to ensure that the hair is oriented at the moment just prior to being cut. Current combs do not offer this functionality.

The disclosed comb design incorporates mechanical aspects that enable the comb attachment to orient the hair to achieve a uniform cut, such as by changing the angle between the hair and scalp so that the hair is substantially taut and perpendicular to the cutting edge. The added components are designed to manipulate and re-orient the strands of hair while they are in the process of being cut. The proposed comb 10 will properly orient the hair relative to the scalp and cutting edge and uniformly bring the hair towards the trimmer cutting edge 102 as the hair is being cut. The proposed comb 10 manipulates the hair by providing sufficient contact with the hair to guide the hair to the trimmer cutting edge 102 in a desired orientation. This additional contact will ensure that short hair is efficiently oriented while long or curly hair is oriented and held taut in order to be cut to the intended length.

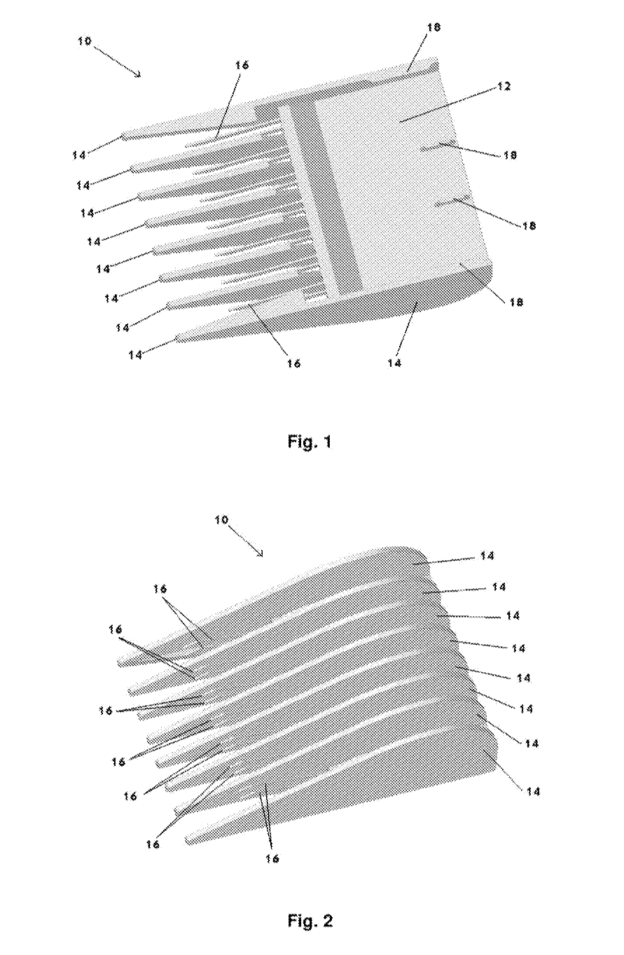

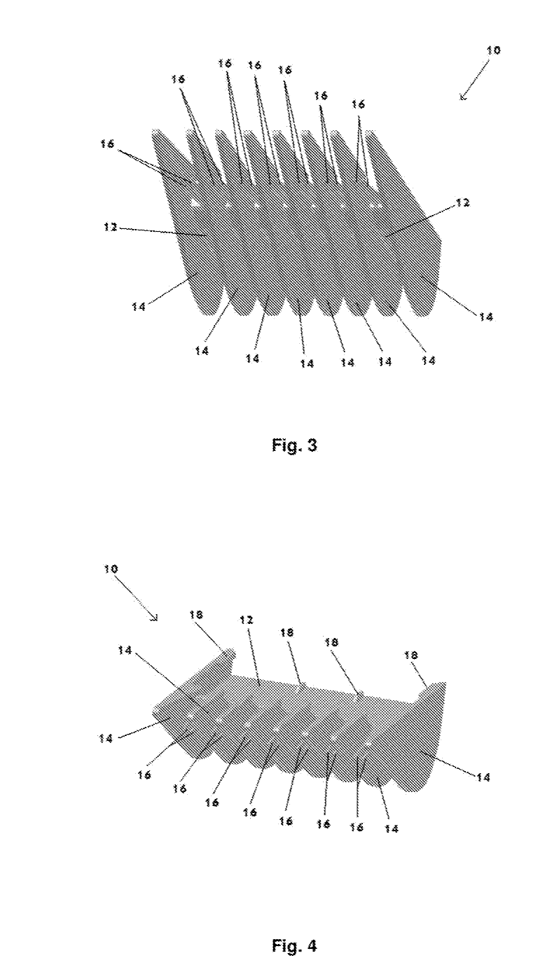

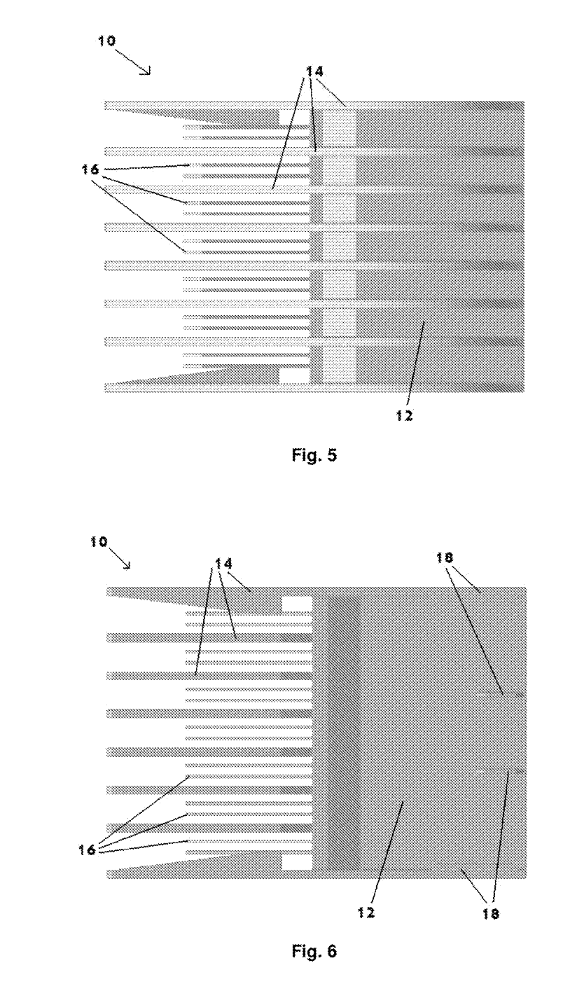

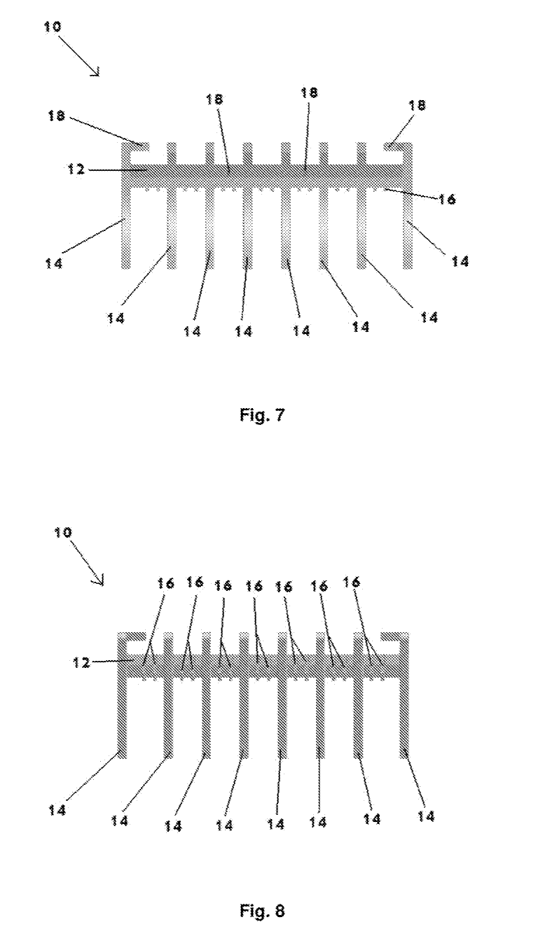

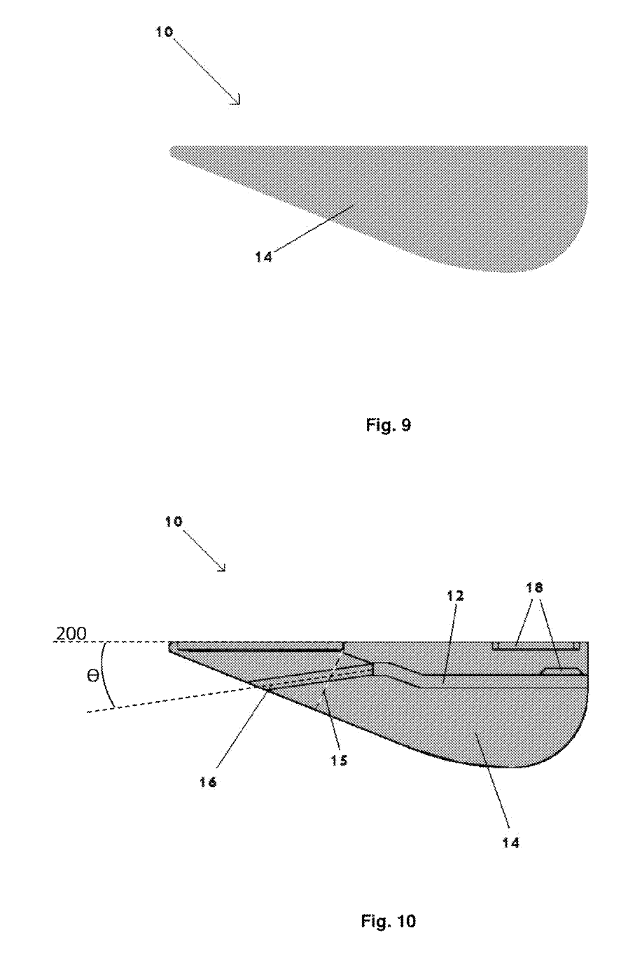

FIGS. 1 through 12 illustrate an exemplary design that provides for the manipulation of hair towards the trimmer cutting edge 102, such as by re-orienting the hair. This is accomplished by incorporating additional comb surface area throughout the comb 10 that manipulates the hair during the cutting process.

The comb 10 includes a base 12, primary teeth 14, and secondary teeth 16. The base 12 of the comb 10 provides the structural strength and various coupling members 18 for securing the comb 10 to a hair trimmer 100. Coupled to the base 12 are the primary teeth 14 and the secondary teeth 16. The primary teeth 14 set the minimum fixed length 15 that the cutting edge 102 is to be distanced from the skin surface, and therefore the desired length at which the hair is to be cut. The comb 10 further includes secondary teeth 16, which provide additional contact surface area with the hair during the cutting process. It is this contact that allows the hair to be manipulated towards the trimmer cutting edge 102. As shown in FIGS. 1-12, the secondary teeth are spaced closer together than the primary teeth and are smaller and finer in design in order to more efficiently penetrate and orient the hair.

The comb base 12 provides coupling members 18 to secure the comb 10 to a hair trimming device 100. The coupling members 18 may be positioned, sized, and shaped as is appropriate for coupling to any existing or newly designed trimming device 100. The coupling members 18 may be protrusions, slots, cavities, screws, and the like, on or in the base 12 as needed to secure the comb 10 to the trimming device 100. In some embodiments, the comb may be integrally formed with the trimming device. These features may be of any suitable size and orientation and may be mounted at any suitable location on the comb 10 or comb base 12. The comb base 12 is designed such that the comb 10 attaches firmly to the hair trimming device 100 to ensure that it does not detach during regular use. The base 12 configuration also allows for easy removal when the trimmer 100 is to be used with a different sized comb 10 or without a comb 10. As shown in FIGS. 1, 4 and 6, coupling members 18 take the form of protrusions and secure the comb 10 to the trimmer 100 such that the cutting edge 102 is perpendicular to the direction in which the primary teeth 14 extend. The comb base 12 provides the structural support and attachment for one or both of the primary 14 and secondary teeth 16.

As discussed above and shown in FIGS. 1-12, the comb 10 may include primary teeth 14 and secondary teeth 16. The primary teeth 14 maintain the desired fixed distance 15 between the trimmer cutting edge 102 and the skin surface. As shown in the example of FIGS. 1-12, the primary teeth 14 extend perpendicularly to the comb base 12 and the trimmer cutting edge 102. The primary teeth 14 are spaced apart such as to always ensure the clipper cutting edge 102 remains at a minimum distance 15 away from the skin surface regardless of the curvature of the skin surface. The height 15 of the primary teeth 14 may be sized to correspond to particular desirable trimming lengths. The width of the primary teeth 14 may be such as to provide sufficient structural strength during regular use in order to remain rigid while also allowing the teeth to easily penetrate the hair. Besides maintaining the fixed distance 15 between the trimmer cutting edge 102 and the skin surface, the primary teeth 14 may take any shape or size provided they do not limit the movement of hair through the comb 10 towards the cutting edge 102. Considerations for the shape of the primary teeth 14 may include, but are not limited to, the comfort of the teeth pushing against the skin, prevention of sharp edges in order to maximize safety, ease of use, providing a compact design to minimize storage space and material costs, product appearance, and the like.

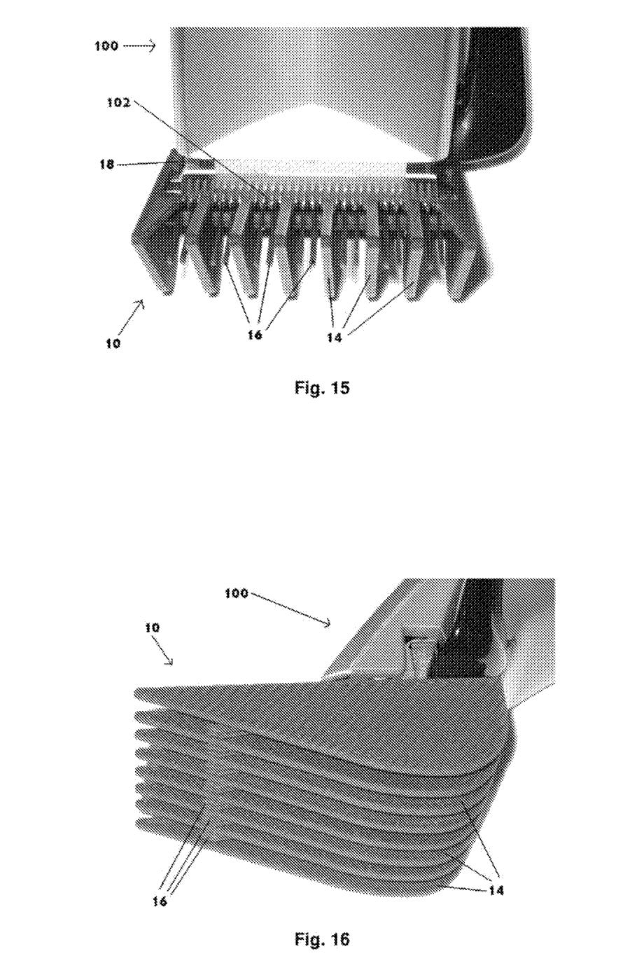

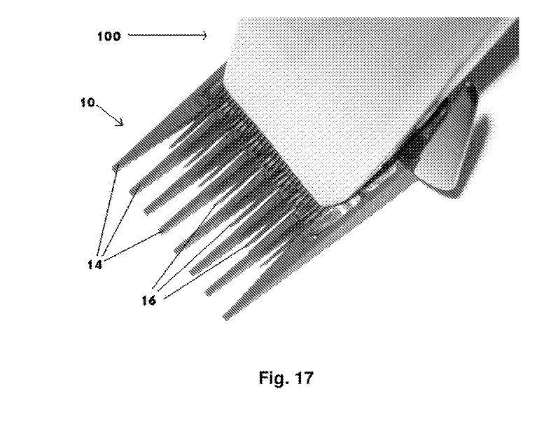

The secondary teeth 16 uniformly manipulate the hair towards the trimmer cutting edge 102 so that the hair is cut to the intended length 15. The secondary teeth 16 provide additional surface area to guide the hair into the optimal position relative to the cutting edge 102 in order to be cut to the intended length 15. As shown in FIGS. 1-12, the secondary teeth 16 extend from the base 12 of the comb 10 and are positioned pointing forward towards the leading edge of the comb as it enters the hair and moves along a path of travel 200. The secondary teeth 16 are disposed at a slight downward angle θ, as shown in FIG. 10. This allows the secondary teeth 16 to penetrate into the hair towards the surface of the skin. The secondary teeth 16 may also be coupled at any other suitable location on the comb 10. As the comb 10 moves over the skin surface the secondary teeth 16 make contact with the hair, re-orienting and lifting as-needed, to guide the hair towards the trimmer cutting edge 102. The size and angle of the secondary teeth 16 may vary according to the size of the comb 10, the width of the primary teeth 14, or the type of hair desired to be cut. As shown in the example of FIGS. 1-12, 15-17 one or more secondary teeth 16 are spaced between the primary teeth 14.

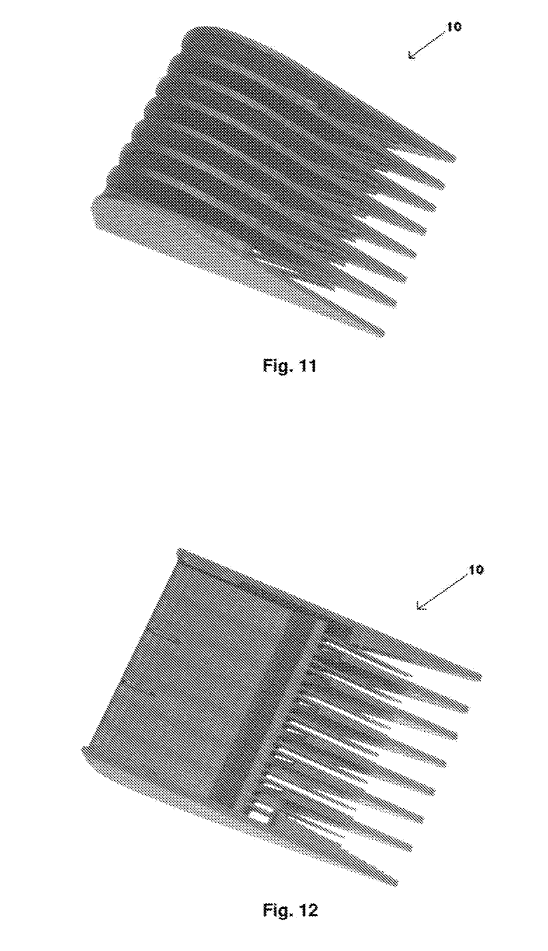

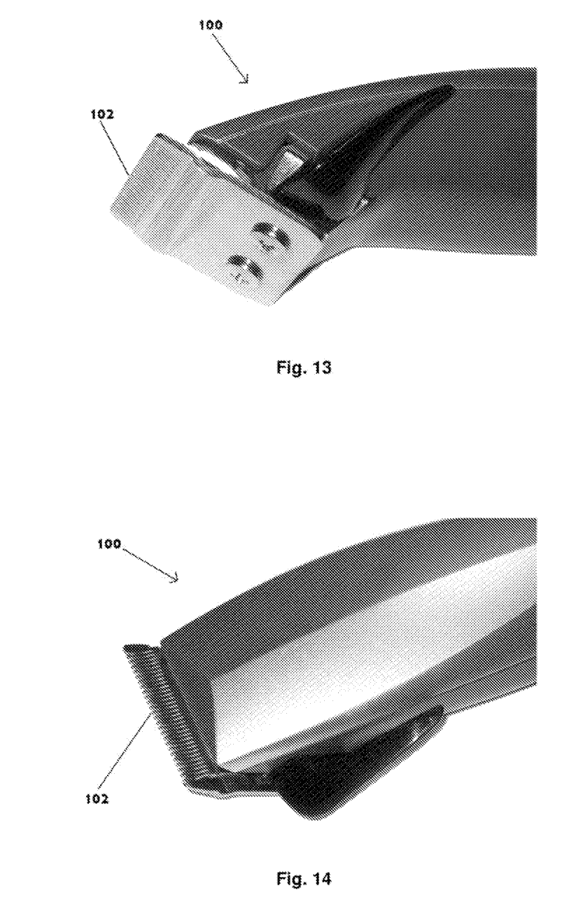

As shown in FIGS. 11, 12, and 15-17, the disclosed comb 10 may be manufactured from acrylonitrile butadiene styrene (ABS) plastic due to its ease of use and cost effectiveness. It should be appreciated that any other plastics or metals could be used.

As shown in the exemplary design, FIGS. 1-12, 15-17, the comb 10 is integrally formed with base 12, primary teeth 14 and secondary teeth 16 all provided in a single unit or comb 10. These various sections may be separate components that couple together to form a desired configuration. As such the secondary teeth 16 may be designed as a separate unit that attaches to any existing comb 10.

The above disclosure provides a comb 10 comprising a base 12 configured to couple to a trimming device 100, primary teeth 14 configured to provide a fixed distance 15 from a cutting edge 102 of the trimming device 100, and secondary teeth 16 configured to manipulate hair to a predetermined orientation relative to the cutting edge 102. In some embodiments, the secondary teeth 16 are disposed between the primary teeth 14.

The above disclosure provides an attachment for a comb 10 comprising secondary teeth 16 configured to be mounted to a comb 10 and further configured to manipulate hair to a predetermined orientation relative to a cutting edge 102. In some embodiments, the secondary teeth 16 are disposed adjacent the primary teeth 14.

Although the invention has been disclosed in its preferred forms, the specific embodiments thereof as disclosed and illustrated herein are not to be considered in a limiting sense, because numerous variations are possible. The subject matter of the invention includes all novel and non-obvious combinations and sub combinations of the various elements, features, functions, and/or properties disclosed herein. No single feature, function, element or property of the disclosed embodiments is essential. The following claims define certain combinations and sub combinations of features, functions, elements, and/or properties that are regarded as novel and non obvious. Other combinations and sub combinations may be claimed through amendment of the present claims or presentation of new claims in this or a related application. Such claims, whether they are broader, narrower, equal, or different in scope to any earlier claims, also are regarded as included within the subject matter of the invention.

What is claimed is:

1. A comb for a hair trimming device comprising:
a base configured to secure the comb to a trimming device;
primary teeth configured to provide a fixed distance from a cutting edge of the trimming device;
and secondary teeth configured to manipulate hair to a predetermined orientation relative to the cutting edge.

2. The comb of claim 1, wherein the secondary teeth are disposed between the primary teeth.

3. The comb of claim 2, wherein the secondary teeth are more narrow than the primary teeth.

4. The comb of claim 2, wherein the secondary teeth are spaced closer together than the primary teeth.

5. The comb of claim 1, wherein the secondary teeth are disposed at an angle relative to a path of travel of the trimming device.

6. An attachment for a hair trimming device comb having primary teeth, the attachment comprising:
secondary teeth configured to be mounted to a comb and further configured to manipulate hair to a predetermined orientation relative to a cutting edge.

7. The attachment of claim 6, wherein the secondary teeth are configured to be mounted to a comb so that the secondary teeth are disposed adjacent to the primary teeth.

8. The comb of claim 6, wherein the secondary teeth are more narrow than the primary teeth.

9. The comb of claim 6, wherein the secondary teeth are spaced closer together than the primary teeth.

10. The comb of claim 6, wherein the secondary teeth are disposed at an angle relative to a path of travel of the trimming device.

11. A hair trimming device comprising:
a plurality of primary teeth configured to provide a fixed distance from a cutting edge trimming device;
and a plurality of secondary tee configured to manipulate hair to a predetermined orientation relative to the cutting edge.

12. The attachment of claim 11, wherein the secondary teeth are disposed between the primary teeth.

13. The comb of claim 11, wherein the secondary teeth are more narrow than the primary teeth.

14. The comb of claim 11, wherein the secondary teeth are spaced closer together than the primary teeth.

15. The comb of claim 11, wherein the secondary teeth are disposed at an angle relative to a path of travel of the trimming device.
